(19) United States
(12) Patent Application Publication
(10) Pub. No.: US 2026/0361556 A1
(43) Pub. Date: Nov. 12, 2026

(54) DISTRIBUTED LEDGER AUTHENTICATION SYSTEM AND METHOD

(71) Applicant: General Electric Company, Evendale, OH (US)

(72) Inventors: Nicolas Kristopher Sabo, Liberty Township, OH (US); Deepak Trivedi, Halfmoon, NY (US); John W. Carbone, Ballston Spa, NY (US)

(21) Appl. No.: 19/202,205

(22) Filed: May 8, 2025

(51) Int. Cl. H04L 9/00; H04L 9/32

(52) U.S. Cl. CPC H04L 9/50; H04L 9/3213; H04L 9/3221

(57) ABSTRACT

A computer-implemented method includes receiving, by a computing system from a computing device, a request to access image data stored in one or more blocks of one or more transactional ledgers. The computing system decrypts the one or more blocks, updates the one or more blocks with the request, and identifies one or more signatories authorized to grant access rights to the image data. The computing system requests validation of the one or more blocks updated with the request by the one or more signatories where the validation defines a grant of the access rights. Responsive to the validation, the image data is provided to the computing device.

### FIELD

The present subject matter relates generally to a distributed ledger authentication system and method.

### BACKGROUND

Exchanging digital data in the form of video, audio, image, text, etc., may include verifying access rights to such data. The data may need to be transferred between one or more data storage platforms and one or more user devices over a communication network. There may be multiple parties involved with the data such as partners, suppliers, and customers that contribute, use, modify, and/or otherwise need to access the data. The data may be proprietary to one or more of those parties such that controlled access is maintained for the parties involved.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a schematic view of an exemplary system distributed ledger authentication system in accordance with an embodiment of the present disclosure.

FIG. 2 is a flow diagram depicting an embodiment of a method of authenticating access to data using a distributed ledger system in accordance with embodiments of the present disclosure.

FIG. 3 provides an example computing system according to example embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Embodiments of the present disclosure provide an authentication system using a transactional ledger or a distributed ledger technology (DLT) with a signatory schema to authenticate access to data. An access token may be assigned to a device when the device requests access to information or data. The device authenticates with the authentication system to receive the access token, which the device can use to access available services and/or data. The access token may have an associated expiration time, after which the access token is void and the device has to again authenticate with the authentication system to receive a new access token. The access token may also be valid for a session which may terminate in response to a logout or connection closure.

In exemplary embodiments, the data forming a basis for the access request is stored in a transactional ledger such as, by way of non-limiting example, in one or more blocks of an authentication blockchain. To authenticate with the authentication system, access to the secure data includes a signatory schema such that one or more signatories receive, validate, and/or update the corresponding blocks to grant or deny access to the data. In exemplary embodiments, the data may be broken down or segmented into data subsets and stored in corresponding blocks of the blockchain such that access to the data is based on a validation of the corresponding block by the respective signatories. In response to access rights being granted to the data, the blocks may be updated with transactional information corresponding to the granted access rights and the data provided to the requesting device.

Thus, embodiments of the present disclosure enable data to be stored in one or more transactional ledgers across one or more data storage platforms. One or more parties may clear or authorize access to data such that a signatory schema is managed in a distributed manner such that proprietary data may be shielded from unauthorized parties. Embodiments of the present disclosure enable access rights to be controlled in a manner that enables visualization of image data to be performed remotely from the party requesting data access such that the data files used to create the visualization are not distributed to, or stored locally by, a user device. Remote visualization of image data using the DLT system of the present disclosure also enables a faster sampling rate of data to be streamed to a user device such as, by way of non-limiting example, augmented reality experiences.

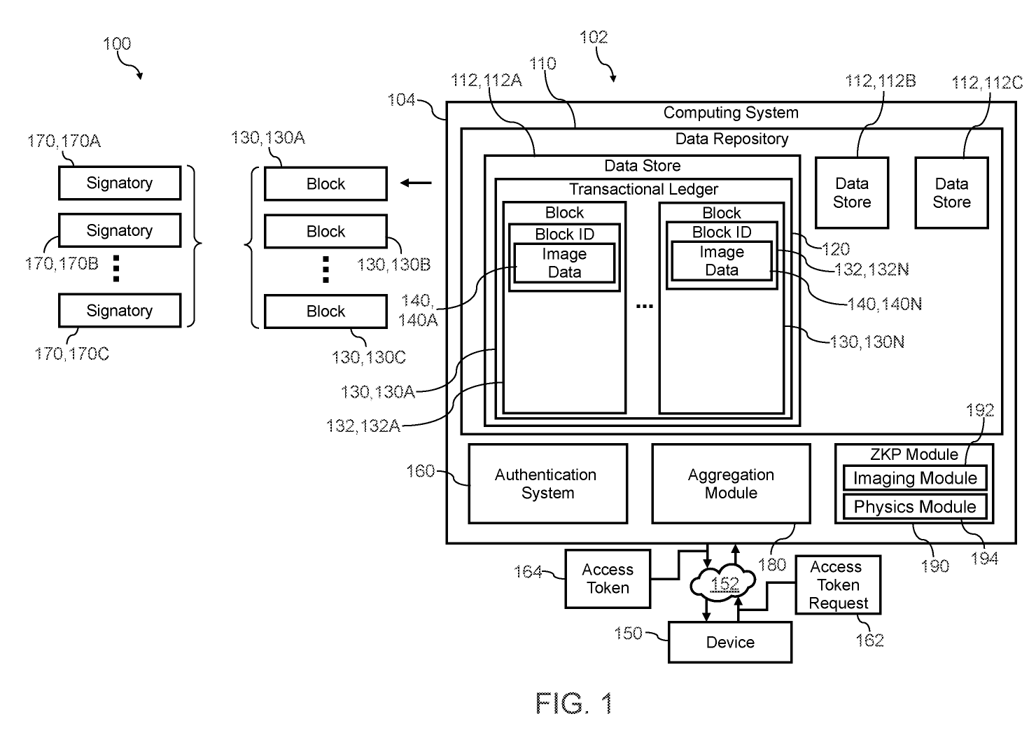

FIG. 1 is a system 100 in which a data relationship management system 102 utilizing distributed ledger technology (DLT) controls the authorization and exchange of data between various parties or entities. Embodiments of the system 100 use a DLT schema to enable controlled authorization and access to data stored in a data repository containing one or more transactional ledgers. To avoid obscuring the inventive subject matter with unnecessary detail, various functional components (e.g., modules) that are not germane to convey an understanding of the inventive subject matter have been omitted from FIG. 1. However, a skilled artisan will readily recognize that various additional functional components may be supported by the illustrated devices to facilitate additional functionality that is not specifically described herein. Furthermore, the various functional modules depicted in FIG. 1 may reside on a single computing device or may be distributed across several computing devices in various arrangements such as those used in cloud-based architectures (e.g., platform as a service). Further, the various functional modules, engines, etc., depicted in FIG. 1 may be implemented in either physical devices, and/or virtual devices.

In the embodiment illustrated in FIG. 1, the system 100 includes the data relationship management system 102 at least partly located on a computing system 104. It should be understood that the data relationship management system 102 may be located in a distributed manner such as, by way of non-limiting example, at least partly disposed on one or more different computing systems 104 such as, by way or non-limiting example, on one or more servers and/or in a cloud-based or other type of distributed network structure. In the embodiment illustrated in FIG. 1, the data relationship management system 102 includes one or more data repositories 110 storing one or more data stores 112. In the depicted embodiment of FIG. 1, there are three data stores 112A, 112B, 112C. However, it should be understood that a greater or fewer quantity of data stores 112 may be used. In exemplary embodiments, each data store 112 may correspond to one or more different entities or parties that contribute data to and/or access data from the respective data store 112. However, it should be understood that multiple parties or entities may contribute data to and/or access data from a particular data store 112.

For ease of description and illustration, data store 112A will be described further below. However, it should be understood that the data stores 112B and 112C may be similarly configured. In exemplary embodiments, the data store 112A includes one or more transactional ledgers 120 storing one or more blocks 130. The one or more blocks 130 are digital containers for a set of validated data and transactions that are securely linked together via cryptographic hashes. In exemplary embodiments, each block 130 includes a block identifier (ID) 132 functioning as a unique identifier of the respective block 130. The block ID 132 may be a hash of the contents of the block 130. By way of non-limiting example, each block 130 may contain a hash of a previous block 130 creating a chained structure where each block 130 is cryptographically linked to the block 130 before it. The block 130 may also include a nonce (e.g., in a header of the block 130) used to generate a hash for creating a new block 130. In the embodiment illustrated in FIG. 1, the block 130 includes image data 140. By way of non-limiting example, the image data 140 may be two-dimensional (2D) and/or three-dimensional (3D) digital representations of one or more objects. However, it should be understood that other types of data may be stored in the blocks 130. In the embodiment depicted in FIG. 1, the transactional ledger 120 includes blocks 130A-130N where “N” represents the n^{th} item of a quantity of items. Thus, in FIG. 1, the block 130N includes a block ID 132N identifying the block 130N, and the block 130N contains the image data 140N.

In exemplary embodiments, the image data 140 from one block 130 may be combined or aggregated with image data 140 from one or more other blocks 130 (e.g., from the same and/or different data stores 112) to depict a visualization of a respective object and/or multiple objects. By way of non-limiting example, a digital representation of one or more objects may be broken down or segmented into data subsets such that the image data 140 stored in a particular block 130 represents a portion and/or layer of an object or combination of objects. The computing system 104 or another computing system may be used to segment data into data subsets that are stored as the image data 140. Thus, each data subset may be a digital representation of a portion of a larger visualization of the object or combination of objects. As a non-limiting example, a visualization of a turbine blade of a gas turbine engine (e.g., an aircraft engine) may be broken down or segmented such that image data 140 in one data store 112 in a particular block 130 may be a data subset that depicts an exterior profile of a turbine blade while image data 140 in another data store 112 and/or in another block 130 in the same data store 112 may be a data subset that depicts internal cooling aspects of the turbine blade. Thus, access to the different data subsets of an object or combination of objects as represented by the image data 140 may be authorized for some users or parties but unauthorized for other users or parties. By way of non-limiting example, a plurality of any of the image data 140A-140N may be aggregated or combined to create a visualization of an object or a portion of an object.

In the embodiment depicted in FIG. 1, the system 100 may include one or more devices 150 configured to communicate with the computing system 104 via one or more communication networks 152. The communication network 152 may be any type of network, including a local area network (“LAN”), such as an intranet, a wide area network (“WAN”), such as the internet, or any combination thereof. Further, the communication network 152 can be a public network, a private network, or a combination thereof. The communication network 152 can be implemented using any number of communication links associated with one or more service providers, including one or more wired communication links, one or more wireless communication links, or any combination thereof. Additionally, the communication network 152 can be configured to support the transmission of data formatted using any number of protocols. Although one device 150 is depicted in FIG. 1, this is only for ease of explanation and is not meant to be limiting. Thus, the system 100 may include any number and variety of devices 150. The one or more devices 150 may by any type of computing device such as, by way of non-limiting example, computer servers, laptops, mobile computing devices, augmented reality (AR) devices, etc. The one or more devices 150 may be used to request access to the data repository 110 to input, modify, and/or store the image data 140 in the data repository 110 and/or retrieve image data 140 from the data repository 110. The one or more devices 150 may also be used to display the image data 140 and/or use the image data 140 as AR data. By way of non-limiting example, the one or more devices 150 may be AR devices that may use the image data 140 as augmenting data. In exemplary embodiments, the one or more devices 150 may use the image data 140 in relation to an AR environment such that one or more virtual objects are rendered in a physical environment to create a composite view for the user of the device 150 in which reality is enhanced by the one or more virtual objects. By way of non-limiting example, the image data 140 may be augmented AR data such that the image data 140 corresponds to one or more virtual components of a gas turbine engine (e.g., an aircraft engine) that are rendered in a physical environment including all or a portion of the gas turbine engine. As another non-limiting example, the image data 140 may be augmented AR data such that the image data 140 corresponds to all or a portion of a virtual representation of the gas turbine engine to enable a user of the device 150 to visualize a component that interfaces with the gas turbine engine. In such scenarios, the granted access may be in the form of a granted access rights session such that changes in a view perspective of the device 150 enables a re-rendering of the image data 140 without repeating the grant authentication process.

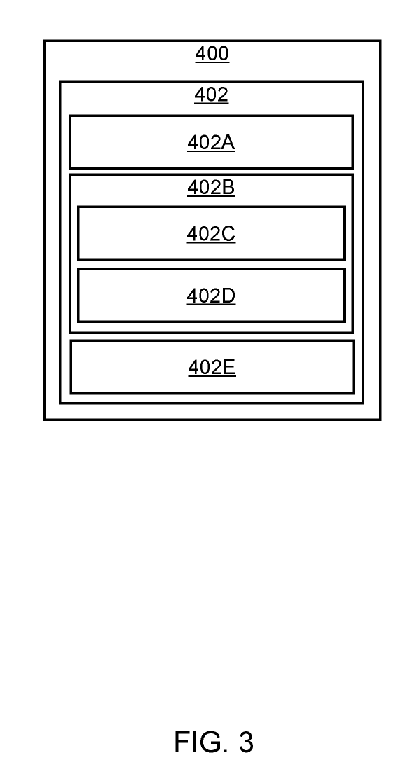

In the embodiment depicted in FIG. 1, the data relationship management system 102 includes an authentication system 160. The authentication system 160 performs authentication functions to provide security control and access to the data repository 110. By way of non-limiting example, the authentication system 160 may receive a request to access the image data 140 contained in one or more of the data stores 112. In exemplary embodiments, the authentication system 160 may receive an access token request 162 from the device 150 and issue an access token 164 to the device 150 that the device 150 includes in requests transmitted to the data repository 110 for services. The access token request 162 may include one or more block IDs 132 or may be a call identifying one or more parts from a parts list or other type of directory identifying the image data 140 that is requested. The authentication system 160 may deny requests from the device 150 that do not include a valid access token 164 or is an old or expired access token 164. By way of non-limiting example, an access request using an old or expired access token 164 may attempt to call a block 130 that has a new nonce such that the request is attempting to call an out-of-date block 130. The access token 164 may include an expiration time, after which the access token 164 is no longer valid for use by the device 150 to request services from the computing system 104. Thus, the device 150 may repeatedly authenticate with the authentication system 160 to receive valid access tokens 164 to request services from the computing system 104. However, it should be understood that the access token 164 may also be a session access token 164 such that the device 150 may be authenticated by the authentication system 160 for a period of time which may terminate in response to a logout or connection closure between the device 150 and the computing system 104. The data relationship management system 102 and/or the computing system 104 may include one or more computing devices configured to provide services to the device 150. The data relationship management system 102, the computing system 104, and/or the device 150 may be configured similar to exemplary computing devices of the computing system 400 described below with reference to FIG. 3.

The authentication system 160 determines whether to issue the access token 164 to the device 150 or grant access to the requested data using a signatory schema based on the data requested by the device 150, such as the image data 140. Based on the image data 140 set forth in the request, the authentication system 160 identifies one or more signatories 170 that are authorized to grant access rights to the image data 140. The signatory 170 may be an owner or source of the image data 140 stored in the data repository 110 and/or may be a party or entity providing access authorization functions based on the device 150, a user of the device 150, and/or the image data 140. By way of non-limiting example, the signatories 170 may be defined by one or more contractual relationships, security relationships, and/or other data management relationships with respect to the image data 140. The one or more signatories 170 may be a participant such as, by way of non-limiting example, a particular individual, group of individuals, or entity, that may possess the authority to grant the access rights. In exemplary embodiments, the one or more signatories 170 may authorize or grant access to the image data 140 requested by the device 150 via the access token and/or by frame-by-frame authentication in the case of streaming content. In exemplary embodiments, image data 140 may be owned and/or sourced by one or more of the signatories 170 such that the one or more signatories 170 grant or deny access rights to the respective image data 140. A particular data store 112 and/or transactional ledger 120 may contain image data 140 owned and/or controlled by a single signatory 170 or a plurality of signatories 170. Thus, for a particular access request, a single signatory 170 or multiple signatories 170 may provide a grant or denial of access rights to the image data 140.

In exemplary embodiments, the authentication system 160 may identify the one or more signatories 170 authorized to grant access rights to the image data 140 and forward the request to the corresponding signatories 170. The one or more signatories 170 may be linked to the data relationship management system 102 via electronic methods such as, by way of non-limiting example, electronic mail, notification via a communication network, such as the communication network 152, or by other methods. The one or more signatories 170 may use one or more electronic devices or computing systems, such as the exemplary computing system 400 depicted in FIG. 4, to interface with the relationship management system 102. By way of non-limiting example, the one or more signatories 170 may receive a notification from the authentication system 160 of the access request via an electronic communication over a communication network in the form of an electronic mail message or other type of electronic notification. As described above, the request may define one or more block IDs 132 corresponding to the image data 140 to which access is requested or may otherwise define the image data 140 that is requested. The authentication system 160 may decrypt one or more blocks 130 defined by the request and update the one or more blocks 130 with the access request information such as, by way of non-limiting example, the device 150 and/or user of the device 150 requesting access, the date and/or time of requested access, the communication network 152 used for access, etc. The authentication system 160 may communicate with the one or more signatories 170 to obtain authorization to grant the access rights to the image data 140. In exemplary embodiments, the authentication system 160 may provide information to the one or more signatories 170 with respect to the access request such as, by way of non-limiting example, the block IDs 132 corresponding to the requested image data 140. Responsive to receiving a notification by the one or more signatories 170 with respect to the access request from the authentication system 160, the one or more signatories 170 may access or interface with the data relationship management system 102 to grant or deny the access request. Additionally or alternatively, the authentication system 160 may forward the one or more updated blocks 130 to the respective signatories 170 for approval or may otherwise request that the one or more signatories 170 interface with the data relationship management system 102 to validate the one or more blocks 130. The one or more signatories 170 may validate the update to the respective one or more blocks 130 to authorize or grant access rights to the respective image data 140. A lack of a validation of the updated block 130 may indicate that access rights are denied for the respective access request. The authentication system 160 may update the respective block 130 based on the granting or denial of access rights to the image data 140 defined by the respective block 130. In the embodiment depicted in FIG. 1, the request identified three blocks 130A, 130B, 130C. The authentication system 160 identified three signatories 170A, 170B, 170C having to authorize or validate the grant of access rights to the device 150 for the image data 140 contained in the blocks 130A, 130B, 130C. A particular block 130A, 130B, 130C may need to be validated by one or more of the signatories 170A, 170B, 170C. By way of non-limiting example, the block 130A may need to be validated by signatory 170A, the block 130B may need to be validated by the signatories 170A and 170B, and the block 130C may need to be validated by the signatory 170C. By way of another non-limiting example, blocks 130A, 130B, 130C may need to be validated by signatory 170A, the block 130B may need to be validated by the signatory 170B, and the block 130C may need to be validated by the signatory 170C. Thus, it should be understood that a particular block 130 may need to be validated by a single signatory 170 or a plurality of signatories 170.

In exemplary embodiments, the data relationship management system 102 may include one or more aggregation modules 180. The one or more aggregation modules 180 may combine and/or aggregate image data 140 from one or more blocks 130 to provide a visualization of the image data 140. In exemplary embodiments, in response to a grant of access rights by the one or more signatories 170 to the requested image data 140, the authentication system 160 may decrypt the one or more blocks 130 and provide the corresponding image data 140 to the aggregation module 180. The aggregation module 180 may combine and/or otherwise render the image data 140 to provide a visualization of the respective image data 140 to the device 150. The visualization of the image data 140 may be in the form of a streaming content and/or one or more images transmitted to the device 150. In non-streaming or non-AR scenarios, the aggregation module 180 may transmit one or more data files to the device 150 such as, by way of non-limiting example, one or more computer-aided design (CAD) files corresponding to the image data 140 to the device 150 to enable the device 150 to render the corresponding image data 140. In response to a completion of the access to the image data 140, the authentication system 160 may update the respective blocks 130 such that further access to the image data 140 requires another access token or grant authorization.

Thus, in exemplary embodiments, the authentication system 160 uses an authentication blockchain to store and authenticate access rights to the image data 140. By way of non-limiting example, the authentication system 160 adds a new entry to and/or updates the authentication blockchain for each access request and grant and/or denial of access rights to the image data 140. Upon receiving an access request from the device 150, the authentication system 160 authenticates access rights to the image data 140 via the one or more signatories 170 from the authentication blockchain. The authentication system 160 may then generate an access token for the device 150 based on the granted rights authorized by the one or more signatories 170 and provide the generated access token to the device 150. Using blockchain technology to store image data 140 and provide access authorization reduces the cost of setting up a trusted authentication system. With the access rights granted by the one or more signatories 170 based on the permissioned nature of blockchain, one or more parties may each control access to respective image data 140 based on the unique responsibilities of each signatory 170 and/or the unique aspects of the image data 140 controlled by a respective signatory 170.

In exemplary embodiments, the authentication system 160 uses the authentication blockchain to store and/or modify the image data 140 to the transactional ledgers 120. By way of non-limiting example, the authentication system 160 adds a new entry to and/or updates the authentication blockchain for each access token request to store the image data 140 to the transactional ledgers 120 and grants and/or denies access rights to store and/or modify the image data 140. Upon receiving an access token request from the device 150, the authentication system 160 authenticates access rights to the image data 140 via the one or more signatories 170 from the authentication blockchain. The authentication system 160 may then generate an access token for the device 150 based on the granted rights authorized by the one or more signatories 170 and provide the generated access token to the device 150. Based on the granted access rights, the authentication system 160 may receive the image data 140 and/or an update to the image data 140 and add a new entry to and/or update the authentication blockchain for each access token request to store and/or update the image data 140.

In the embodiment depicted in FIG. 1, the data relationship management system 102 may also include one or more zero-knowledge proof (ZKP) modules 190. In exemplary embodiments, access to data stored in the one or more transactional ledgers 120 and/or responses to inquiries that may be based on the data stored in the one or more transactional ledgers 120 may be generated and/or provided by the one or more ZKP modules 190. A zero-knowledge proof refers to a method by which one party or device proves or provides to another party certain information or responses without conveying any information beyond what is necessary to establish the veracity of the information or responses. In other words, by way of non-limiting example, a ZKP may indicate that a component A will interface with a component B without conveying image data 140 corresponding to the component B. The ZKP module 190 may be used to provide a ZKP with respect to compliance with license and/or export terms, while maintaining data confidentiality. Thus, in exemplary embodiments, the ZKP module 190 will enable parties to verify critical information, such as adherence to contractual terms, component compatibility and/or applicability of repair procedure, without exposing sensitive business details or proprietary data. As described above, the transactional ledgers 120 may store lifecycle events or data as blockchain transactions (e.g., as one or more blocks 130) to provide traceability and transparency. The data stored in the one or more blocks 130 may include, by way of non-limiting example, timestamps, people and/or parties involved in a transaction, inspection logs, sensor readings, digital signatures, hashes of documents, images and/or videos. Additionally, large documents may be stored off-chain (e.g., outside the transactional ledgers 120) while having its hash stored on the chain (e.g., as one or more blocks 130).

As described above, the data relationship management system 102 uses a signatory 170 schema in connection with the blocks 130 in one or more transactional ledgers 120 to ensure only verified and/or authorized entities can access or write to the blocks 130. Access to data held by the blocks 130 may be pursuant to predefined data sharing agreements and can utilize ZKPs that anonymize transactions without revealing data stored in the blocks 130. Thus, embodiments of the present disclosure enable parties to exchange transaction information without verifying each other's identity using the ZKPs. By way of non-limiting example, the ZKP module 190 can provide ZKPs that confirm if components were replaced following replacement protocols without revealing detailed logs from other parties. The ZKP module 190 may be used to provide ZKPs that establish that a component is certified and sourced from an authorized supplier without disclosing supplier identity. The ZKP module 190 may be used to provide ZKPs that prove contractual terms (e.g., service intervals, life-limited part lifecycles, etc.) are met without exposing terms such as exact schedules. The ZKP module 190 may be also used to provide ZKPs that prevent sharing of sensitive and/or proprietary data. As described above, the ZKP module 190 may utilize the image data 140 to provide ZKPs that verify whether a component will fit in an engine without disclosing the image data 14 or, in other words, without disclosing CAD files of the engine. As a further non-limiting example, the ZKP module 190 may utilize the image data 140 to provide ZKPs that confirm that, during a component inspection, confirm if the component meets certain tolerance limits without revealing a detailed image or CAD files corresponding to the component. The ZKP module 190 may utilize the image data 140 to provide ZKPs that verify if a borescope will be able to access a given location inside an engine without sharing CAD files of the engine.

In exemplary embodiments, the ZKP module 190 may interface with the aggregation module 180 to utilize rendered image data 140 to derive and/or generate the ZKPs. Additionally or alternatively, the ZKP module 190 may include one or more imaging modules 192 and/or one or more physics modules 194. The one or more imaging modules 192 may include one or more routines, modules, and/or software plug-ins that provide spatial analysis of image data, such as the image data 140, that may be in the form of CAD or other types of 2D or 3D image files. The one or more physics models 194 may be one or more routines, modules, and/or software plug-ins that generate a physics simulation using one or more image files, such as the one or more image files 140.

Thus, in exemplary embodiments, the ZKP module 190 may receive the access token request from the device 150 and interface with the authentication system 160 to determine whether to grant access rights to the requested information, which may be based on the image data 140. In exemplary embodiments, the authentication system 160 authenticates access rights to the image data 140 via the one or more signatories 170 from the authentication blockchain. The authentication system 160 may then generate an access token for the device 150 based on the granted rights authorized by the one or more signatories 170 and provide the generated access token to the ZKP module 190. The ZKP module 190 may interface with the aggregation module 180 and/or utilize one or more of the imaging modules 192 and/or the physics modules 194 to provide a ZKP response to the device 150. By way of non-limiting example, the ZKP module 190 may analyze rendered visualizations of the image data 140 performed by the aggregation module 180 and/or the imaging modules 192. The ZKP module 190 may generate a physics simulation using visualizations of one or more of the image files 140 based on the requested information from the device 150. The ZKP module 190 provides the ZKP response to the device 150 based on the results of the analysis of the image data 140.

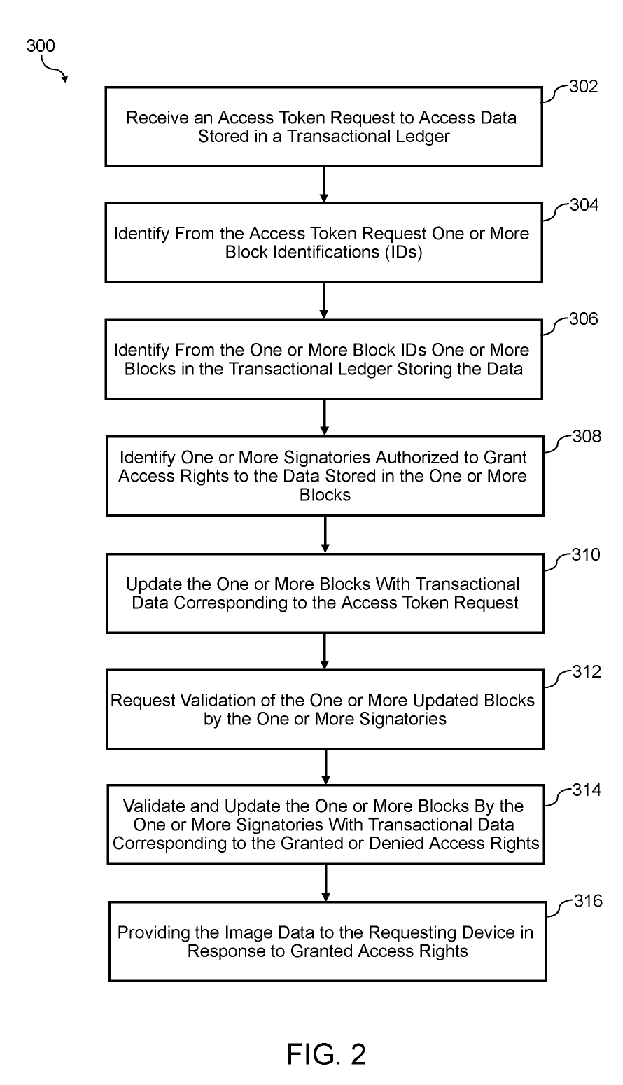

FIG. 2 is a flow diagram depicting an embodiment of a method 300 for authenticating and granting access rights to data stored in a transactional ledger according to embodiments of the present disclosure. The method 300 begins at step 302 where an access token request is received from a device, such as the device 150, to access data stored in one or more transactional ledgers, such as the one or more transactional ledgers 120. At step 304, the method 300 includes identifying, from the access token request, one or more block IDs, such as the one or more block IDs 132. At step 306, the method 300 includes identifying, from the one or more block IDs, one or more blocks in the one or more transactional ledgers storing the data, such as the one or more blocks 130 storing the image data 140.

At step 308, the method 300 includes identifying one or more signatories authorized to grant access rights to the data, such as the one or more signatories 170. The one or more blocks may define the one or more signatories authorized to grant access rights to the data and/or the one or more signatories may be defined by the particular transactional ledgers storing the one or more blocks. By way of non-limiting example, the authentication system 160 may identify a first signatory 170 corresponding to first image data 140 stored in a first block 130 of a first transactional ledger 120 and identify a second signatory 170 corresponding to second image data 140 stored in a second block 130 of a second transactional ledger 120. By way of further non-limiting example, a different signatory 170 may correspond to each data store 112 such that, based on the source location of the requested data, a particular signatory 170 is identified for granting the access rights.

At step 310, the method 300 includes updating the one or more blocks with transactional data corresponding to the access token request. By way of non-limiting example, the authentication system 160 may decrypt the block 130 and update the block 130 with information corresponding to the access token request such as the device 150, identity information of a user of the device 150, the communication network 152 associated with the access request token, the date and/or time of the access request token, and/or other information related to the access token request. At step 312, the method 300 includes requesting validation of the one or more updated blocks by one or more signatories authorized to grant access rights to the data, such as the one or more signatories 170. At step 314, the method 300 includes validating and updating the one or more blocks by the one or more signatories with transactional data corresponding to the granted or denied access rights. In exemplary embodiments, the one or more signatories 170 may decrypt the updated block 130 and further update the respective block 130 with information corresponding to a grant or denial of access rights. The update to the block 130 may include an approval or disapproval designation, a date and/or time of the approval or disapproval designation, a duration of grant (e.g., a particular time period or session access token for the granted access rights), and/or other information corresponding to the granted or denied access rights. At step 316, the method 300 includes providing the requested data to the device, such as the device 150, in response to granted access rights authorized by the one or more signatories. As described above, the aggregation module 180 may combine and/or aggregate one or more blocks of the data, such as one or more of the blocks 130 of the image data 140, and render the data if the data is for a visualization of one or more objects. The aggregated data may be provided to the device 150 in a manner corresponding to the type of data such as, by way of non-limiting example, rendered images of the image data 140 and/or streaming visualization content to the device 150.

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus or computing system to produce a machine, such that the instructions, which execute via the processor of the computer or other programmable data processing apparatus, implement the functions/acts specified in the flowchart and/or block diagram block or blocks.

FIG. 3 provides an example computing system 400 according to example embodiments of the present disclosure. The computing devices or elements described herein, such as the device 105 and/or the computing system 104, may include various components and perform various functions of the computing system 400 described below, for example.

As shown in FIG. 3, the computing system 400 can include one or more computing device(s) 402. The computing device(s) 402 can include one or more processor(s) 402A and one or more memory device(s) 402B. The one or more processor(s) 402A can include any suitable processing device, such as a microprocessor, microcontroller, integrated circuit, logic device, and/or other suitable processing device. The one or more memory device(s) 402B can include one or more computer-executable or computer-readable media, including, but not limited to, non-transitory computer-readable media, RAM, ROM, hard drives, flash drives, and/or other memory devices.

The one or more memory device(s) 402B can store information accessible by the one or more processor(s) 402A, including computer-readable instructions 402C that can be executed by the one or more processor(s) 402A. The computer-readable instructions 402C can be any set of instructions that when executed by the one or more processor(s) 402A, cause the one or more processor(s) 402A to perform operations. In some embodiments, the computer-readable instructions 402C can be executed by the one or more processor(s) 402A to cause the one or more processor(s) 402A to perform operations, such as any of the operations and functions for which the computing system 400 and/or the computing device(s) 402 are configured, such as performing the functions and/or operations of the authentication system 160, the aggregation module 180, the ZKP module 190, the imaging module 192, the physics module 194, and/or the operations of FIG. 2. The computer-readable instructions 402C can be software written in any suitable programming language or can be implemented in hardware. Additionally, and/or alternatively, the computer-readable instructions 402C can be executed in logically and/or virtually separate threads on processor(s) 402A. The memory device(s) 402B can further store data 402D that can be accessed by the processor(s) 402A. For example, the data 402D can include models, lookup tables, databases, etc. By way of non-limiting example, the memory device(s) 402B may store or implement the data stores 112 with the transactional ledgers 120, the blocks 130, and the image data 140.

The computing device(s) 402 can also include a network interface 402E used to communicate, for example, with the other components of the computing system 400 (e.g., via a communication network). The network interface 402E can include any suitable components for interfacing with one or more network(s), including for example, transmitters, receivers, ports, controllers, antennas, and/or other suitable components. One or more devices can be configured to receive one or more commands from the computing device(s) 402 or provide one or more commands to the computing device(s) 402.

The technology discussed herein makes reference to computer-based systems and/or computer-implemented actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Accordingly, embodiments of the present disclosure enable data to be stored in one or more transactional ledgers across one or more data storage platforms. One or more parties may clear or authorize access to data such that a signatory schema is managed in a distributed manner such that proprietary data may be shielded from unauthorized parties. Embodiments of the present disclosure enable access rights to be controlled in a manner that enables visualization of image data to be performed remotely from the party requesting data access such that the data files used to create the visualization are not distributed to, or stored locally by, a user device. Remote visualization of image data using the DLT system of the present disclosure also enables a faster sampling rate of data to be streamed to a user device such as, by way of non-limiting example, augmented reality experiences.

Further aspects are provided by the subject matter of the following clauses:

A non-transitory computer storage medium storing computer-useable instructions that, when executed by a computing system, cause the computing system to: receive, from a computing device, a request to access image data stored in one or more blocks of one or more transactional ledgers; decrypt the one or more blocks; update the one or more blocks with the request; identify one or more signatories authorized to grant access rights to the image data; request validation of the one or more blocks updated with the request by the one or more signatories, the validation defining a grant of the access rights; and responsive to the validation, provide the image data to the computing device.

The non-transitory computer storage medium of the preceding clause, wherein the computer-useable instructions, when executed by the computing system, cause the computing system to update the one or more blocks with transactional data corresponding to at least one of a user of the computing device, a time of the request, or a communication network associated with the request.

The non-transitory computer storage medium of any preceding clause, wherein the computer-useable instructions, when executed by the computing system, cause the computing system to update the one or more blocks with transactional data corresponding to the grant of the access rights.

The non-transitory computer storage medium of any preceding clause, wherein the computer-useable instructions, when executed by the computing system, cause the computing system to: receive, from the computing device, an update to the image data; and update the one or more blocks based on the updated image data.

The non-transitory computer storage medium of any preceding clause, wherein the computer-useable instructions, when executed by the computing system, cause the computing system to: render the image data; and provide the rendered image data to the computing device.

The non-transitory computer storage medium of any preceding clause, wherein the image data comprises augmented reality data, and wherein the computer-useable instructions, when executed by the computing system, cause the computing system to grant the access rights as an access rights session.

The non-transitory computer storage medium of any preceding clause, wherein the one or more transactional ledgers comprise a first transactional ledger comprising first image data and a second transactional ledger comprising second image data, and wherein the computer-useable instructions, when executed by the computing system, cause the computing system to: identify a first signatory of the corresponding to the first image data; and identify a second signatory corresponding to the second image data.

A non-transitory computer storage medium storing computer-useable instructions that, when executed by a computing system, cause the computing system to: receive, from a computing device, a request for an access token, the access token authorizing access to data stored in one or more blocks of one or more transactional ledgers; decrypt the one or more blocks; update the one or more blocks with the access token request; identify one or more signatories authorized to grant the access token request; request validation of the one or more blocks updated with the access token request by the one or more signatories, the validation defining a grant of the access token request; and provide, to the computing device, a result of a zero-knowledge proof (ZKP) generated by the computing system based on the data.

The non-transitory computer storage medium of any preceding clause, wherein the data comprises image data, and wherein the computer-useable instructions, when executed by the computing system, cause the computing system to provide the result of the ZKP based on the image data.

The non-transitory computer storage medium of any preceding clause, wherein the computer-useable instructions, when executed by the computing system, cause the computing system to: perform one or more physics simulations using the data; and provide the result of the ZKP based on the one or more physics simulations.

The non-transitory computer storage medium of any preceding clause, wherein the one or more transactional ledgers comprise a first transactional ledger comprising first data and a second transactional ledger comprising second data, and wherein the computer-useable instructions, when executed by the computing system, cause the computing system to: identify a first signatory corresponding to the first data; and identify a second signatory corresponding to the second data.

The non-transitory computer storage medium of any preceding clause, wherein the data comprises image data, and wherein the computer-useable instructions, when executed by the computing system, cause the computing system to: render the image data; and provide the result of the ZKP based on the rendered image data.

The non-transitory computer storage medium of any preceding clause, wherein the data comprises a digital representation of a three-dimensional (3D) object, and wherein the computer-useable instructions, when executed by the computing system, cause the computing system to: segment the data into a plurality of data subsets; and store the plurality of data subsets in the one or more blocks.

The non-transitory computer storage medium of any preceding clause, wherein the computer-useable instructions, when executed by the computing system, cause the computing system to: aggregate the plurality of data subsets; and provide the result of the ZKP based on the aggregation of the plurality of data subsets.

A method, comprising: receiving, by a computing system from a computing device, a request to access image data stored in one or more blocks of one or more transactional ledgers, the access request defining one or more block identifications (IDs) defining the image data; in response to receiving the request: identifying, by one or more computer processors of an authentication system, one or more signatories authorized to grant access rights to the image data; verifying, by the authentication system, that the one or more signatories have granted the access rights; and providing the image data to the computing device.

The method of the preceding clause, further comprising updating the one or more blocks with transactional data corresponding to the request.

The method of any preceding clause, further comprising updating the one or more blocks with transactional data corresponding to the granted access rights.

The method of any preceding clause, further comprising: receiving an update to the image data; and updating the one or more blocks based on the updated image data.

The method of any preceding clause, further comprising: rendering the image data; and wherein providing the image data comprises transmitting the rendered image data to the computing device.

The method of any preceding clause, wherein the image data comprises augmented reality data, the method further comprising generating the access rights as an access rights session.

The method of any preceding clause, wherein the one or more transactional ledgers comprise a first transactional ledger comprising first image data and a second transactional ledger comprising second image data, the method further comprising: identifying, by the authentication system, a first signatory corresponding to the first image data; and identifying, by the authentication system, a second signatory corresponding to the second image data.

The method of any previous clause, wherein the one or more blocks comprise a plurality of blocks, the method further comprising aggregating the data from the plurality of blocks to form a visualization of the data.

The method of any preceding clause, wherein the request includes one or more block identifications (IDs) defining the image data.

A method, comprising: receiving, by a computing system from a computing device, a request for an access token, the access token authorizing access to data stored in one or more blocks of one or more transactional ledgers, the access token including one or more block identifications (IDs) defining the data; in response to receiving the request: identifying, by one or more computer processors of an authentication system, from the one or more block IDs, one or more signatories corresponding to the data, the one or more signatories authorized to grant access rights to the data; verifying, by the authentication system, that the one or more signatories have granted the access rights; and providing a result of a zero-knowledge proof (ZKP) generated by the computing system based on the data to the computing device.

The method of any preceding clause, wherein the data comprises image data, and wherein providing the result comprises providing the result of the ZKP generated by the computing system based on the image data.

The method of any preceding clause, further comprising updating the one or more blocks with transactional data corresponding to the access token.

The method of any preceding clause, further comprising updating the one or more blocks with transactional data corresponding to the granted access rights.

The method of any preceding clause, wherein the one or more transactional ledgers comprise a first transactional ledger comprising first data and a second transactional ledger comprising second data, the method further comprising: identifying, by the authentication system, a first signatory corresponding to the first data; and identifying, by the authentication system, a second signatory corresponding to the second data.

The method of any preceding clause, further comprising: segmenting the image data into a plurality of data subsets; and storing the plurality of data subsets in the one or more transactional ledgers.

The method of any preceding clause, wherein the data comprises image data, and further comprising: rendering the image data; and providing the result of the ZKP generated by the computing system based on the rendered image data.

The method of any preceding clause, wherein the data comprises a digital representation of a three-dimensional (3D) object, the method further comprising: segmenting the data into a plurality of data subsets; and storing the plurality of data subsets in the one or more blocks.

The method of any preceding clause, further comprising: aggregating the plurality of data subsets; and providing the result of the ZKP generated by the computing system based on the aggregation of the plurality of data subsets.

A system, comprising: a data repository containing one or more transactional ledgers, the one or more transactional ledgers defining one or more blocks in the respective one or more transactional ledgers storing image data; and one or more computing systems configured to: receive a request for an access token from a computing device requesting access to the image data, the access token authorizing access to the image data, the request defining one or more block identifications (IDs) corresponding to the one or more blocks; identify, from the one or more block IDs, one or more signatories corresponding to the image data, the one or more signatories authorized to grant access rights to the image data; verify that the one or more signatories have granted the access rights; provide the image data to the computing device.

The system of any preceding clause, wherein the one or more computing systems are configured to: render the image data; and transmit the rendered image data to the computing device.

The system of any preceding clause, wherein the one or more computing systems are configured to update the one or more blocks with transactional data corresponding to the access token.

The system of any preceding clause, wherein the one or more computing systems are configured to update the one or more blocks with transactional data corresponding to the granted access rights.

The system of any preceding clause, wherein the image data comprises a digital representation of a three-dimensional (3D) object, and wherein the one or more computing systems are configured to: segment the image data into a plurality of data subsets; and store the plurality of data subsets in the one or more transactional ledgers, each data subset of the plurality of data subsets defined by the respective one or more block IDs.

The system of any preceding clause, wherein the one or more transactional ledgers comprise a first transactional ledger comprising first image data and a second transactional ledger comprising second image data, and wherein the one or more computing systems are configured to: identify a first signatory corresponding to the first image data; and identify a second signatory corresponding to the second image data.

The system of any preceding clause, wherein the one or more computing systems are configured to: segment the image data into a plurality of data subsets; and store the plurality of data subsets in the one or more transactional ledgers.

The system of any preceding clause, wherein the one or more blocks comprise a plurality of blocks, and wherein the one or more computing systems are configured to aggregate the image data from the plurality of blocks.

A non-transitory computer storage medium storing computer-useable instructions that, when executed by one or more computing systems, cause the one or more computing systems to: receive a request for an access token from a computing device, the access token authorizing access to image data stored in one or more blocks of one or more transactional ledgers, the access token including one or more block identifications (IDs) defining the image data; identify, from the one or more block IDs, one or more signatories corresponding to the image data, the one or more signatories authorized to grant access rights to the image data; verify that the one or more signatories have granted the access rights; and provide the image data to the computing device.

A non-transitory computer storage medium storing computer-useable instructions that, when executed by one or more computing systems, cause the one or more computing systems to: receive a request for an access token from a computing device, the access token authorizing access to data stored in one or more blocks of one or more transactional ledgers, the access token including one or more block identifications (IDs) defining the data; identify, from the one or more block IDs, one or more signatories corresponding to the data, the one or more signatories authorized to grant access rights to the data; verify that the one or more signatories have granted the access rights; and provide a result of a zero-knowledge proof (ZKP) based on the data to the computing device.

A system, comprising: a data repository containing one or more transactional ledgers, the one or more transactional ledgers defining one or more blocks in the respective one or more transactional ledgers storing data; and one or more computer processors configured to: receive a request for an access token from a computing device, the access token authorizing access to the data, the access token including one or more block identifications (IDs) defining the data; identify, from the one or more block IDs, one or more signatories corresponding to the data, the one or more signatories authorized to grant access rights to the data; verify that the one or more signatories have granted the access rights; and providing a result of a zero-knowledge proof (ZKP) generated based on the data to the computing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A non-transitory computer storage medium storing computer-useable instructions that, when executed by a computing system, cause the computing system to:
receive, from a computing device, a request to access image data stored in one or more blocks of one or more transactional ledgers;
decrypt the one or more blocks;
update the one or more blocks with the request;
identify one or more signatories authorized to grant access rights to the image data;
request validation of the one or more blocks updated with the request by the one or more signatories, the validation defining a grant of the access rights; and
responsive to the validation, provide the image data to the computing device.

2. The non-transitory computer storage medium of claim 1, wherein the computer-useable instructions, when executed by the computing system, cause the computing system to update the one or more blocks with transactional data corresponding to at least one of a user of the computing device, a time of the request, or a communication network associated with the request.

3. The non-transitory computer storage medium of claim 1, wherein the computer-useable instructions, when executed by the computing system, cause the computing system to update the one or more blocks with transactional data corresponding to the grant of the access rights.

4. The non-transitory computer storage medium of claim 1, wherein the computer-useable instructions, when executed by the computing system, cause the computing system to:
receive, from the computing device, an update to the image data; and
update the one or more blocks based on the updated image data.

5. The non-transitory computer storage medium of claim 1, wherein the computer-useable instructions, when executed by the computing system, cause the computing system to:
render the image data; and
provide the rendered image data to the computing device.

6. The non-transitory computer storage medium of claim 1, wherein the image data comprises augmented reality data, and wherein the computer-useable instructions, when executed by the computing system, cause the computing system to grant the access rights as an access rights session.

7. The non-transitory computer storage medium of claim 1, wherein the one or more transactional ledgers comprise a first transactional ledger comprising first image data and a second transactional ledger comprising second image data, and wherein the computer-useable instructions, when executed by the computing system, cause the computing system to:
identify a first signatory of the corresponding to the first image data; and
identify a second signatory corresponding to the second image data.

8. A non-transitory computer storage medium storing computer-useable instructions that, when executed by a computing system, cause the computing system to:
receive, from a computing device, a request for an access token, the access token authorizing access to data stored in one or more blocks of one or more transactional ledgers;
decrypt the one or more blocks;
update the one or more blocks with the access token request;
identify one or more signatories authorized to grant the access token request;
request validation of the one or more blocks updated with the access token request by the one or more signatories, the validation defining a grant of the access token request; and
provide, to the computing device, a result of a zero-knowledge proof (ZKP) generated by the computing system based on the data.

9. The non-transitory computer storage medium of claim 8, wherein the data comprises image data, and wherein the computer-useable instructions, when executed by the computing system, cause the computing system to provide the result of the ZKP based on the image data.

10. The non-transitory computer storage medium of claim 8, wherein the computer-useable instructions, when executed by the computing system, cause the computing system to update the one or more blocks with transactional data corresponding to the granted access token request.

11. The non-transitory computer storage medium of claim 8, wherein the computer-useable instructions, when executed by the computing system, cause the computing system to:
perform one or more physics simulations using the data; and
provide the result of the ZKP based on the one or more physics simulations.

12. The non-transitory computer storage medium of claim 8, wherein the one or more transactional ledgers comprise a first transactional ledger comprising first data and a second transactional ledger comprising second data, and wherein the computer-useable instructions, when executed by the computing system, cause the computing system to:
identify a first signatory corresponding to the first data; and
identify a second signatory corresponding to the second data.

13. The non-transitory computer storage medium of claim 8, wherein the data comprises image data, and wherein the computer-useable instructions, when executed by the computing system, cause the computing system to:
render the image data; and
provide the result of the ZKP based on the rendered image data.

14. The non-transitory computer storage medium of claim 8, wherein the data comprises a digital representation of a three-dimensional (3D) object, and wherein the computer-useable instructions, when executed by the computing system, cause the computing system to:
segment the data into a plurality of data subsets; and
store the plurality of data subsets in the one or more blocks.

15. The non-transitory computer storage medium of claim 14, wherein the computer-useable instructions, when executed by the computing system, cause the computing system to:
aggregate the plurality of data subsets; and
provide the result of the ZKP based on the aggregation of the plurality of data subsets.

16. A system, comprising:
a data repository containing one or more transactional ledgers, the one or more transactional ledgers defining one or more blocks in the respective one or more transactional ledgers storing image data; and
one or more computing systems configured to:
receive an access token request from a computing device requesting access to the image data, the access token request defining one or more block identifications (IDs) corresponding to the one or more blocks;
identify, from the one or more block IDs, one or more signatories corresponding to the image data, the one or more signatories authorized to grant the access token request;
decrypt the one or more blocks;
update the one or more blocks with the access token request;
request validation of the one or more blocks updated with the access token request by the one or more signatories, the validation defining a grant of the access token request; and
provide the image data to the computing device.

17. The system of claim 16, wherein the computing system is configured to:
render the image data; and
transmit the rendered image data to the computing device.

18. The system of claim 16, wherein the computing system is configured to update the one or more blocks with transactional data corresponding to the grant of the access token request.

19. The system of claim 16, wherein the computing system is configured to update the one or more blocks with an update to the image data.

20. The system of claim 16, wherein the image data comprises a digital representation of a three-dimensional (3D) object, and wherein the one or more computing systems are configured to:
segment the image data into a plurality of data subsets; and
store the plurality of data subsets in the one or more transactional ledgers, each data subset of the plurality of data subsets defined by the respective one or more block IDs.
